(19) United States
(12) Patent Application Publication
(10) Pub. No.: US 2021/0350209 A1
(43) Pub. Date: Nov. 11, 2021

(54) INTENT AND CONTEXT-AWARE DIALOGUE BASED VIRTUAL ASSISTANCE

(71) Applicants: Jin WANG, Shanghai (CN); Hao HUANG, Shanghai (CN); Ting-Kun LI, Shanghai (CN); Nai-Long WEN, Shanghai (CN); Zhen CUI, Shanghai (CN); David BARON, Encinitas, CA (US); MICRO FOCUS LLC, Provo, UT (US)

(72) Inventors: Jin WANG, Shanghai (CN); Hao HUANG, Shanghai (CN); Ting-Kun LI, Shanghai (CN); Nai-Long WEN, Shanghai (CN); Zhen CUI, Shanghai (CN); David BARON, Encinitas, CA (US)

(21) Appl. No.: 17/278,437

(22) PCT Filed: Sep. 28, 2018
(86) PCT No.: PCT/CN2018/108261

§ 371 Date: Mar. 22, 2021

(51) Int. Cl. G06N 3/04; G06F 16/332; G06F 16/33; G06N 3/08

(52) U.S. Cl. CPC G06N 3/0427; G06N 3/08; G06F 16/3344; G06F 16/3329

(57) ABSTRACT

In some examples, with respect to intent and context-aware dialogue based virtual assistance, an intent of an inquiry may be determined using an intent classification model. A determination may be made as to whether the determined intent matches a pre-specified intent of a plurality of pre-specified intents. Based on a determination that the determined intent does not match the pre-specified intent, a question related to the inquiry may be generated. Another intent of the inquiry may be determined by analyzing a response to the question using the intent classification model. A determination may be made as to whether the determined other intent matches another pre-specified intent of the plurality of pre-specified intents. Based on a determination that the determined other intent does not match the other pre-specified intent, a deep learning model may be utilized to predict a response to the inquiry.

### BACKGROUND

In the field of user assistance, a user may pose an inquiry to an assistant who may attempt to respond to the user's inquiry. The response to the user's inquiry may include factors that are subjective to the assistant. For example, the assistant may subjectively attempt to determine a basis for the user's inquiry. Once the assistant has determined the basis for the user's inquiry, the assistant may generate a response that may be subjective to the assistant's understanding of the user's inquiry, and/or the assistant's understanding of available options for responding to the user's inquiry.

### BRIEF DESCRIPTION OF THE DRAWINGS

Features of the present disclosure are illustrated by way of example and not limited in the following figure(s), in which like numerals indicate like elements, in which:

FIG. 1 illustrates an example layout of an apparatus for intent and context-aware dialogue based virtual assistance;

FIG. 2 illustrates a logical flowchart and a functional layer diagram for the apparatus of FIG. 1;

FIG. 3 illustrates training data definition graphical user interface for intent classification to illustrate operation of the apparatus of FIG. 1,

FIG. 4 illustrates an example of an original dialogue to illustrate operation of the apparatus of FIG. 1;

FIG. 5 illustrates a context-aware training data set to illustrate operation of the apparatus of FIG. 1;

FIG. 6 illustrates a diagram of a support vector machine classifier to illustrate operation of the apparatus of FIG. 1;

FIG. 7 illustrates a dual encoder long short-term memory to build a retrieval-based virtual agent to illustrate operation of the apparatus of FIG. 1;

FIG. 8 illustrates an example block diagram for intent and context-aware dialogue based virtual assistance;

FIG. 9 illustrates an example flowchart of a method for intent and context-aware dialogue based virtual assistance; and

FIG. 10 illustrates a further example block diagram for intent and context-aware dialogue based virtual assistance.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Apparatuses for intent and context-aware dialogue based virtual assistance, methods for intent and context-aware dialogue based virtual assistance, and non-transitory computer readable media having stored thereon machine readable instructions to provide intent and context-aware dialogue based virtual assistance are disclosed herein. The apparatuses, methods, and non-transitory computer readable media disclosed herein provide an artificial intelligence based virtual agent to assist a user by responding to an inquiry presented by the user. The virtual agent may utilize a deep neural network to facilitate adaptive learning based on an ever increasing amount of user data. The apparatuses, methods, and non-transitory computer readable media disclosed herein may utilize natural language processing and deep machine learning to leverage existing real conversation history associated with the user, as well as other users. The architecture design of the apparatuses as described herein may combine both intent identification, and context-aware dialogue response recommendation, which may be based on a deep learning long short-term memory network. Further, for the apparatuses, methods, and non-transitory computer readable media disclosed herein, the natural language processing vocabulary may be updated so that the adaptive learning as disclosed herein becomes more specific to a latest training data set. The apparatuses, methods, and non-transitory computer readable media disclosed herein may also utilize a meaning based context-aware content store to provide more relevant response candidates based on a domain related dialogue history.

With respect to user inquiries, service desks of enterprises, organizations, and other such entities, may utilize virtual agents to facilitate, in conjunction with live agents, handling of various user requests (e.g., customer service requests) to reduce operational costs. In this regard, a virtual agent may be implemented by using various rules and patterns to scan for keywords within an input inquiry, and to then ascertain a response from a database based, for example, on a number of matching keywords, a word pattern, etc. For such rules and patterns based virtual agents, it is technically challenging to assess a user dialogue that is not predefined. In this regard, natural language processing and machine learning algorithm based technologies may be utilized to determine a user's intent. In this regard, intent may be described as a user's inferred purpose for an inquiry. Context, as used herein, may be described as a subject of an inquiry. However, it is technically challenging to engage in an ongoing free-form conversation with a user, and to maintain context over time.

The apparatuses, methods, and non-transitory computer readable media disclosed herein address the aforementioned technical challenges by integrating organizational logic, natural language processing, and deep machine learning technology to leverage existing conversation history of a user, or a plurality of users.

According to examples described herein, the apparatuses, methods, and non-transitory computer readable media disclosed herein may address the aforementioned technical challenges by implementing an architecture that combines both intent identification, as well as context-aware dialogue response recommendation, which may be based on a deep learning long short-term memory network.

According to examples described herein, the apparatuses, methods, and non-transitory computer readable media disclosed herein may implement an architecture that includes a natural language processing layer that may update a vocabulary list utilized by the natural language processing layer so that the adaptive learning as disclosed herein becomes more specific to a latest training data set.

According to examples described herein, the apparatuses, methods, and non-transitory computer readable media disclosed herein may also include a meaning based context-aware content store to provide more specific response candidates based on domain related dialogue history.

According to examples described herein, for the apparatuses, methods, and non-transitory computer readable media disclosed herein, a user support service may implement an artificial intelligence powered virtual agent that starts with a limited number of intents to perform a set of well-defined tasks with a pre-trained natural language understanding classifier. As a complementary component, an initial trained conversational virtual agent with an existing large scale public dialog corpus may be used to retain end-users engaged in a conversation to finally determine correct answers or actions. The capability of learning transfer of a deep neural network may enable the virtual agent to continuously gain memory by adaptive learning with ever increasing user data.

According to examples described herein, the apparatuses, methods, and non-transitory computer readable media disclosed herein may utilize natural language processing and deep learning technology to integrate the intent identification and context-aware conversational responses to make a virtual agent feasible and more intelligent.

In examples described herein, module(s), as described herein, may be any combination of hardware and programming to implement the functionalities of the respective module(s). In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

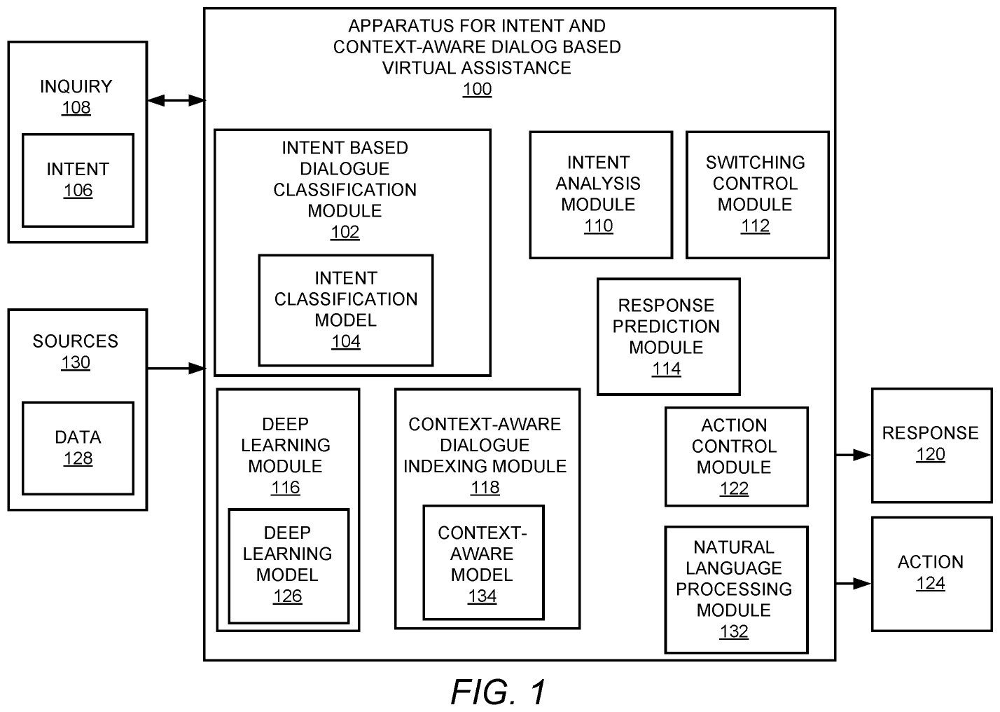

FIG. 1 illustrates an example layout of an apparatus for intent and context-aware dialogue based virtual assistance (hereinafter also referred to as “apparatus 100”). The apparatus 100 may be implemented as a virtual agent as disclosed herein.

Referring to FIG. 1, the apparatus 100 may include an intent based dialogue classification module 102 to determine, using an intent classification model 104, an intent 106 of an inquiry 108.

According to examples disclosed herein, the intent based dialogue classification module 102 may categorize different types of sentences to an intent category of a plurality of intent categories. The intent based dialogue classification module 102 may train the intent classification model 104 based on the categorization of the different types of sentences to the intent category of the plurality of intent categories.

An intent analysis module 110 may determine whether the determined intent matches a pre-specified intent of a plurality of pre-specified intents. Based on a determination that the determined intent does not match the pre-specified intent, the intent analysis module 110 may generate a question related to the inquiry 108. The intent analysis module 110 may determine, by analyzing a response to the question using the intent classification model 104, another intent of the inquiry 108. The intent analysis module 110 may determine whether the determined other intent matches another pre-specified intent of the plurality of pre-specified intents.

Based on a determination that the determined other intent does not match the other pre-specified intent, a switching control module 112 may switch processing with respect to the inquiry 108 to a response prediction module 114 that utilizes a deep learning module 116 and a context-aware dialogue indexing module 118 to predict a response to the inquiry 108.

According to examples disclosed herein, the switching control module 112 may determine, after completion of a specified number of attempts related to inquiry intent determination of the inquiry 108, whether the inquiry intent is determined. Based on a determination that the inquiry intent is not determined, the switching control module 112 may utilize the deep learning module 116 and the context-aware dialogue indexing module 118 to predict a response to the inquiry 108. According to examples disclosed herein, the specified number of attempts maybe greater than two (e.g., three specified number of attempts).

The response prediction module 114 may generate, based on the predicted response, a response 120 to the inquiry 108. For example, the response prediction module 114 may generate a plurality of predicted responses, from which the response 120 may be determined as disclosed herein.

According to examples disclosed herein, based on a determination that the determined intent matches the pre-specified intent, an action control module 122 may perform an action 124 associated with the inquiry 108.

According to examples disclosed herein, the deep learning module 116 may generate a deep learning model 126. In this regard, the deep learning module 116 may train, based on an analysis of data 128 ascertained from sources 130 such as a public domain corpus, a user dialogue database that stores historical dialogues between users, and/or a real-time dialogue between users, the deep learning model 126.

According to examples disclosed herein, a natural language processing module 132 may update a vocabulary list that is used to perform natural language processing based on an analysis of the analyzed data 128. Further, the natural language processing module 132 may implement, using the updated vocabulary list, natural language processing on the analyzed data 128. The deep learning module 116 may train, based on the natural language processed data, the deep learning model 126.

According to examples disclosed herein, the context-aware dialogue indexing module 118 may determine a context of the inquiry 108. Further, the response prediction module 114 may determine, by analyzing the context of the inquiry 108, a plurality of possible responses to the inquiry 108. The response prediction module 114 may also utilize the deep learning model 126 to predict, based on an analysis of the plurality of possible responses, the response to the inquiry 108.

According to examples disclosed herein, the response prediction module 114 may the rank each response of the plurality of possible responses to the inquiry 108 according to a relevance of a respective response to the inquiry. In this regard, the response prediction module 114 may utilize the deep learning model 126 to predict, based on an analysis of the ranked plurality of possible responses, the response to the inquiry 108.

According to examples disclosed herein, the context-aware dialogue indexing module 118 may generate a context-aware training data set by appending each new sentence of a conversation based on historical dialogues between users, and/or a real-time dialogue between users, to a previous sentence of the conversation. Further, the context-aware dialogue indexing module 118 may utilize the context-aware training data set to generate a context-aware model 134 to determine the context of the inquiry 108.

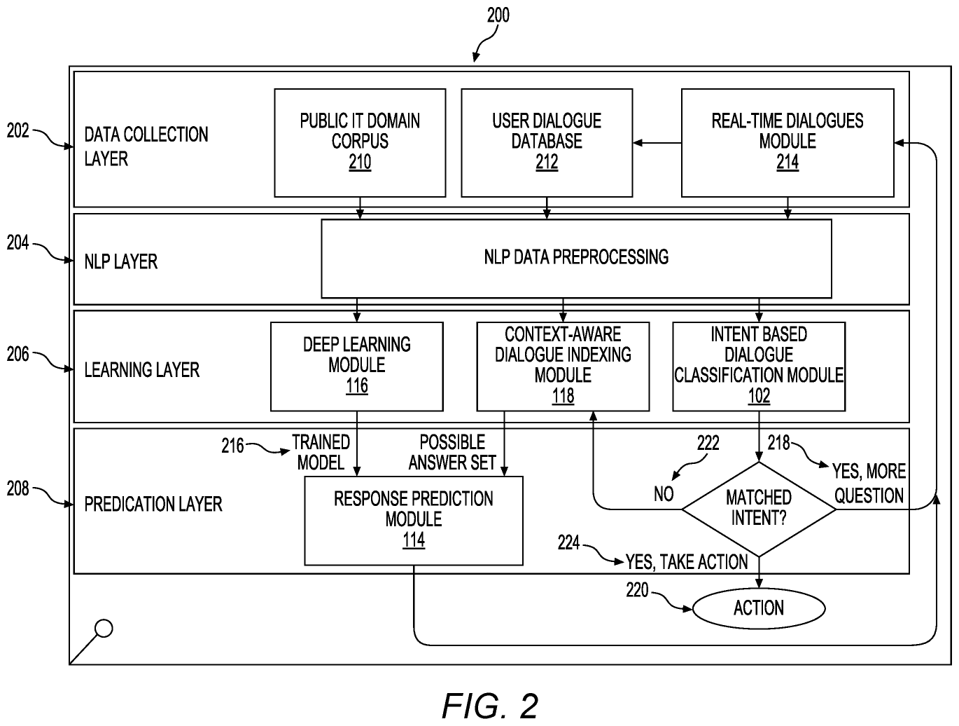

FIG. 2 illustrates a logical flowchart and a functional layer diagram 200 for the apparatus 100.

Referring to FIG. 2, the logical flowchart and the functional layer diagram 200 may include, for example, two main logical process flows, and four functional layers. The two main logical process flows may be implemented by the intent based dialogue classification module 102 and the context-aware dialogue indexing module 118.

For the intent based dialogue classification module 102, when a user inputs an inquiry 108, the intent based dialogue classification module 102 may identify the possible intent, and return the corresponding responses with a limited number of pre-defined intents that may be trained by natural language processing-based questions and answer samples. The user may either accept the answer/action, or the user may reject the answer/action. After a specified number of attempts and failures, if the correct predefined answer is not determined, the switching control module 112 may process the inquiry 108 using the context-aware dialogue indexing module 118.

The context-aware dialogue indexing module 118 may index a history of conversations. For example the conversations may include a publicly available dialogue corpus, and/or user specific conversation history that may include conversations associated with the user as well as other users. When the switching control module 112 switches to the context-aware dialogue indexing module 118, the context-aware dialogue indexing module 118 may generate a rank of possible responses based on a previous user history, and the best response may be selected for the user.

A logical flowchart and a functional layer diagram 200 of the apparatus 100 may include functional layers that include a data collection layer 202, a natural language processing layer 204, a learning layer 206, and a prediction layer 208.

The data collection layer 202 may collect data 128 from a plurality of sources 130. For example, the first source may include a public information technology domain corpus 210. The public information technology domain corpus 210 may be described as an open domain. The public information technology domain corpus 210 may be utilized with a deep learning neural network for initial training. In this regard, according to examples disclosed herein, for information technology domain technical services, the UBUNTU DIALOGUE CORPUS may be utilized as an initial training data set.

The data collection layer 202 may further include a user dialogue database 212. The user dialogue database 212 may represent a data source in which dialogue history may be saved in a user database. In this regard, a user (e.g., customer) support service desk may record actual human-to-human (e.g., user-to-agent) conversation history in the user dialogue database 212. The user dialogue database 212 may be used to train or tune a pre-trained virtual agent implemented by the apparatus 100. In this regard, the dialogues may be received from both real time agent-user chats as well as from off-line agent-user conversations that take form of ticket updates/comments. Both of these sources may be utilized for training.

The data collection layer 202 may further include is a real-time dialogues module 214. In this regard, real-time input may be used by a virtual agent implemented by the apparatus 100 to generate a corresponding response. The dialogue history from the input and the response may be saved in a database, such as the user dialogue database 212, for future training.

The natural language processing layer 204 may perform data preprocessing to convert raw data into formatted data that may be used, for example, for machine learning as disclosed herein.

The natural language processing layer 204 may include a data cleansing process that includes the definition of cleansing rules and algorithms to filter out “dirty” data, which may include improper wording, emoji icons, and other data that has been specified as being unacceptable. The natural language processing layer 204 may include tokenization to extract individual words. For example, individual words may be extracted by tokenization of the dialogue history, and a vocabulary list may be built based on this extraction. A machine-readable instructions library may be generated to incrementally update the vocabulary list.

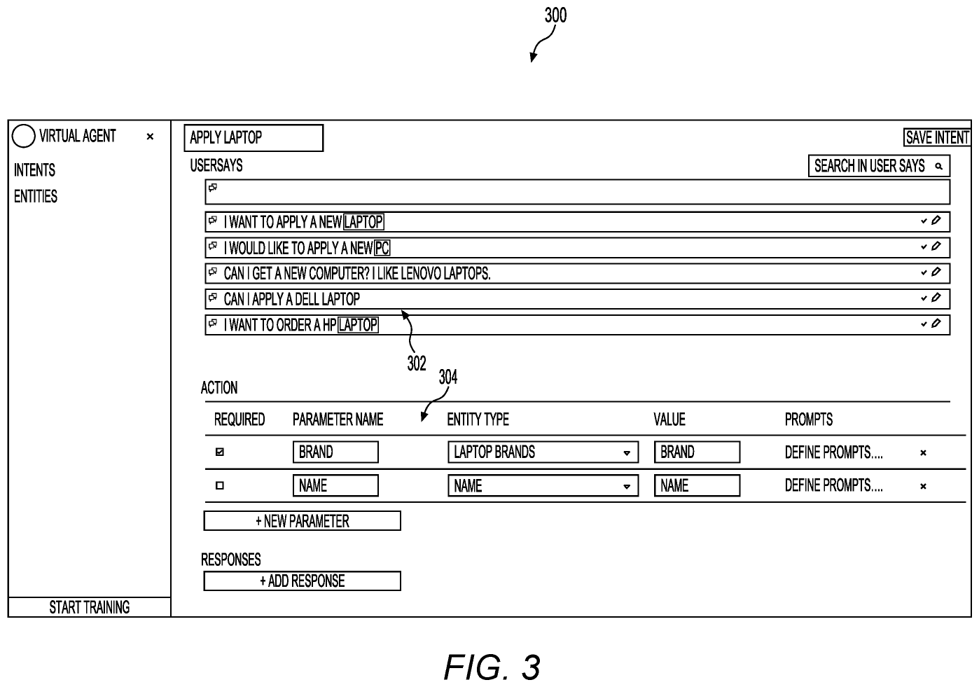

The natural language processing layer 204 may include building of a training data set for intent. In this regard, a graphical user interface may be generated to allow a virtual agent administrator to assign different types of sentences to an intent category. This may be described as a natural language understanding training data set. For example, FIG. 3 illustrates training data definition graphical user interface 300 for intent classification to illustrate operation of the apparatus 100. Referring to FIG. 3, for a given intent, several sentences that may be said by the user are illustrated at 302. These sentences may be classified, for example, as shown at 304 different intent categories. These examples of sentences at 302 may be used as training data for intent classification.

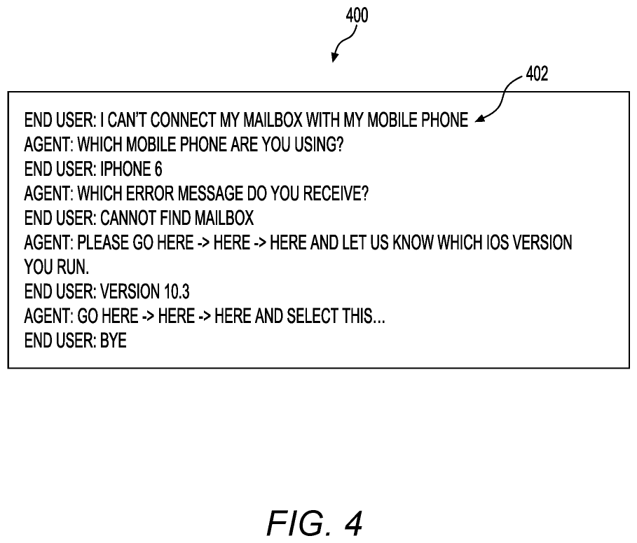

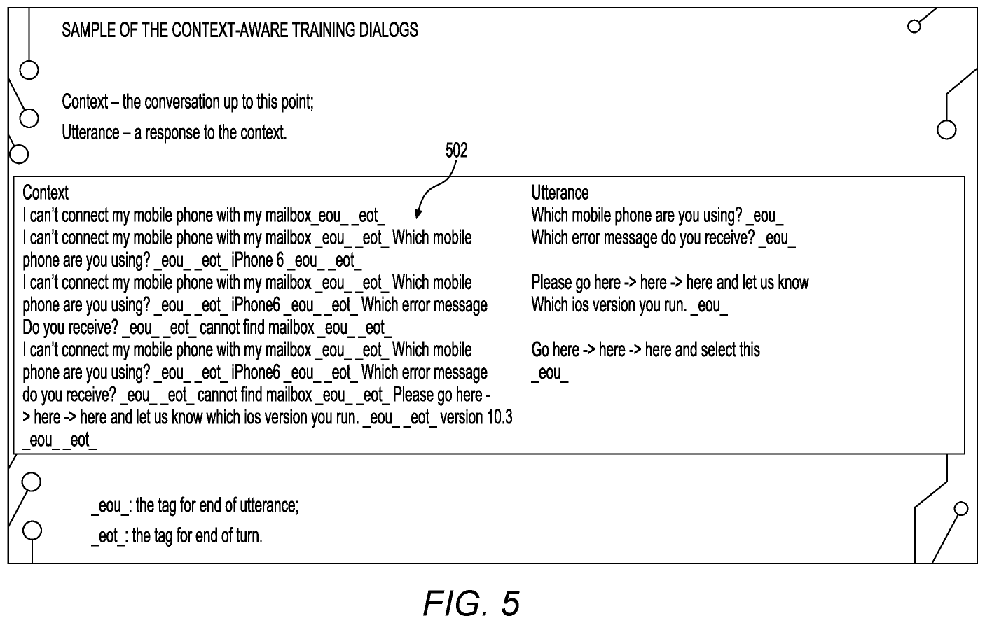

Referring again to FIG. 2, with respect to the context-aware dialogue indexing module 118, a context-aware training data set may be generated for dialogue. In this regard, a technical challenge with respect to a conversational virtual agent may include focusing conversation on what has been talked about before, that is, making the conversation context-aware. In order to address this technical challenge, the context-aware training data set may be generated based on raw dialogue history. In this regard, FIG. 4 illustrates an example of an original dialogue 400 to illustrate operation of the apparatus 100. Further, FIG. 5 illustrates a context-aware training data set 500 for the context-aware model 134 to illustrate operation of the apparatus 100.

Referring to FIG. 4, an example of a dialogue for technical support is illustrated. Further, for this example of FIG. 4, the context-aware training data set is shown in FIG. 5. Referring to FIGS. 4 and 5, the training data set for the context-aware model 134 may be created by appending each new turn of the dialogue to the previous conversation, shown in FIG. 5 at 502. Thus, the correct utterance (response) maybe context-aware. For example, in FIG. 4 at 402, the dialogue begins with the inquiry “I can't connect my mailbox with my mobile phone”, which includes a response “Which mobile phone are you using?” In FIG. 5, at 502, the response “Which mobile phone are you using?” may be appended to the inquiry “I can't connect my mailbox with my mobile phone”. Other inquiries and responses may be similarly appended to generate the training data set for the context-aware model 134.

Referring again to FIG. 2, the learning layer 206 may include machine learning classification, textual meaning indexing, and a deep learning neural network, respectively implemented by the intent based dialogue classification module 102, the context-aware dialogue indexing module 118, and the deep learning module 116.

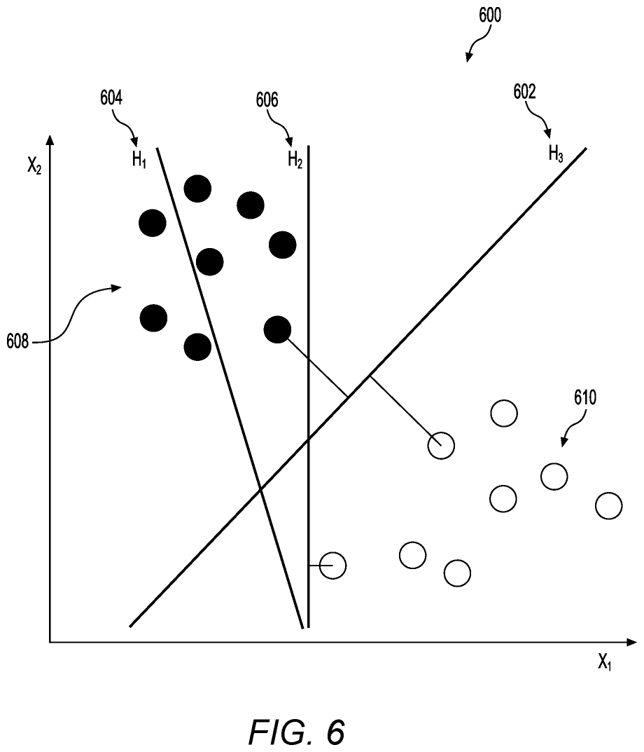

With respect to the intent based dialogue classification module 102, a support vector machine model or a neural network may be used to train a classification functionality of the intent based dialogue classification module 102 with predefined training data created, for example, as disclosed herein with respect to building of a training data set for intent. The intent based dialogue classification module 102 may perform a classification function to ascertain a specific intent that has been predefined based, for example, on enterprise or operation scenarios. The support vector machine model may be described as a representation of examples as points in space, mapped so that the examples of the separate categories are divided by a clear gap that is as wide as possible. New examples may then be mapped into the same space, and predicted to belong to a category based on which side of the gap they fall. In this regard, FIG. 6 illustrates a diagram 600 of a support vector machine classifier to illustrate operation of the apparatus 100. Referring to FIG. 6, a support vector machine is illustrated to determine the best boundary (H₃) at 602 between two classes. For example, the support vector machine may determine boundaries H₁ at 604, H₂ at 606, and H₃ at 602. However, the boundary (H₃) at 602 may be determined as the best boundary between two classes at 608 and 610. The boundaries may be used to classify a conversation or a textual statement to a particular class to ascertain a specific intent.

The context-aware dialogue indexing module 118 may store and index dialogue history in the same format as context-aware training data set in a content store. In this regard, the context component and utterance component may be saved in two fields of the same record. When a real-time dialogue is input, the content store may identify, for example, top N candidates of responses based on the most top N similar meaning context with the input.

The deep learning module 116 may utilize a recurrent neural network with long short-term memory cells to produce the best response based on context-aware dialogue. According to examples, the deep learning module 116 may utilize, for example, retrieval-based or generative models to generate the conversational virtual agent implemented by the apparatus 100. Retrieval-based models may utilize a repository of predefined responses, and some type of heuristic to pick an appropriate response based on the input and context. Retrieval-based models may not generate any new text, but may pick a response from a preselected data set. In this regard, deep learning techniques may be used for either retrieval-based or generative models. According to examples disclosed herein, the deep learning module 116 may utilize a retrieval-based virtual agent with dual encoder long short-term memory recurrent neural network.

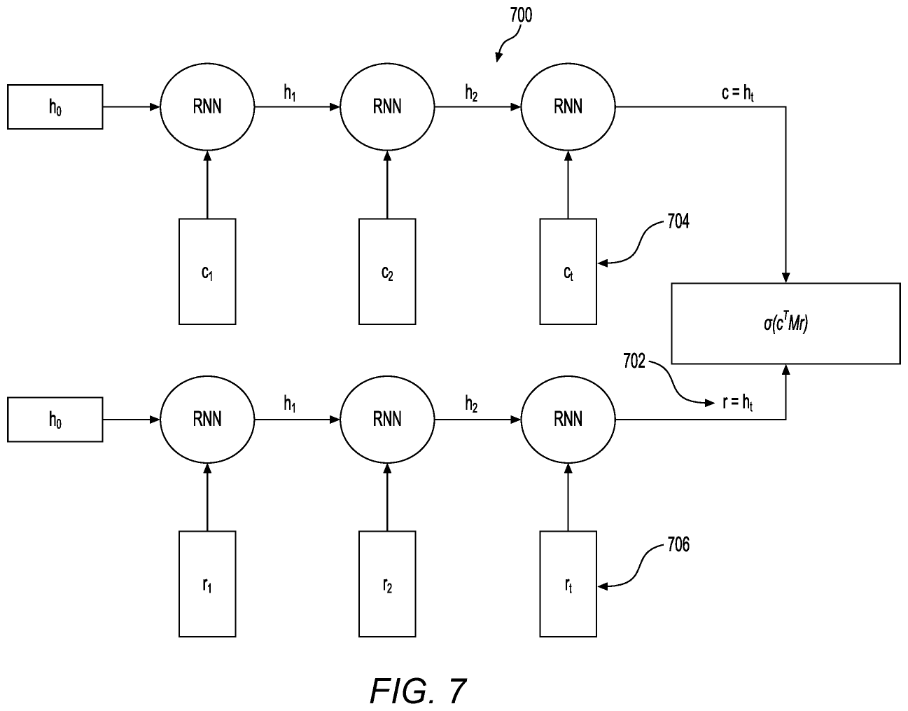

FIG. 7 illustrates a dual encoder long short-term memory 700 to build a retrieval-based virtual agent to illustrate operation of the apparatus 100.

Referring to FIG. 7, input to the retrieval-based model may include a context c (the conversation up to a specified point) and a potential response r at 702. The retrieval-based model may generate an output that includes a score for the response. In order to determine an acceptable response, the score may be determined for multiple responses, and the response with the highest score may be selected. For FIG. 7, cₜ at 704 may represent context at time t, and rₜ at 706 may represent a corresponding response, and σ(c^{T} Mr) may represent that the probability of output is correct.

Referring again to FIG. 2, with respect to the prediction layer 208, after off-line training of the models in the learning layer 206, the trained models at 216 may be implemented, for example, in an online operational mode. The trained models may predict a response for a given real-time input.

With respect to the prediction layer 208 and intent classification, when an inquiry 108 is received, for example, by the user, the intent based dialogue classification module 102 may predict an intent with a highest probability that is higher than a predefined threshold. After an intent is identified, the virtual agent implemented by the apparatus 100 may ascertain additional entity information (e.g., at 218), and/or take an action (e.g., at 220) if all of the needed information is available. If the intent based dialogue classification module 102 does not determine the proper intent, and an additional inquiry or a plurality of inquiries may be generated to classify a user's intent. If the intent is still not identified, at 222, the virtual agent implemented by the apparatus 100 may switch the process of predicting a possible dialogue response to the response prediction module 114.

At the response prediction module 114, the live dialogue context may be used to search a set of candidate responses from the index dialogue history. Further, the same live dialogue context may be fed to the pre-trained deep long short-term memory network. The long short-term memory generated response may be compared with the candidate history responses, and the associated probabilities may be ranked. The best candidate response may be used as the predicted response 120. In addition to determining the best response for a dialogue, direct output of a plurality of responses may also be used as a live agent assistant. For example, a live agent may pick up the most suitable response based on the ranking. This functionality of the virtual agent implemented by the apparatus 100 may be described as a semi-automated mode that may be utilized as the models associated with the learning layer 206 are being trained.

When an intent is identified, and all needed information is collected during the interaction, at 224, the virtual agent implemented by the apparatus 100 may issue a command to perform a goal driven action. This may constitute a completion of the support session. The human-to-human or human-to-machine conversation history may be saved for future adaptive training.

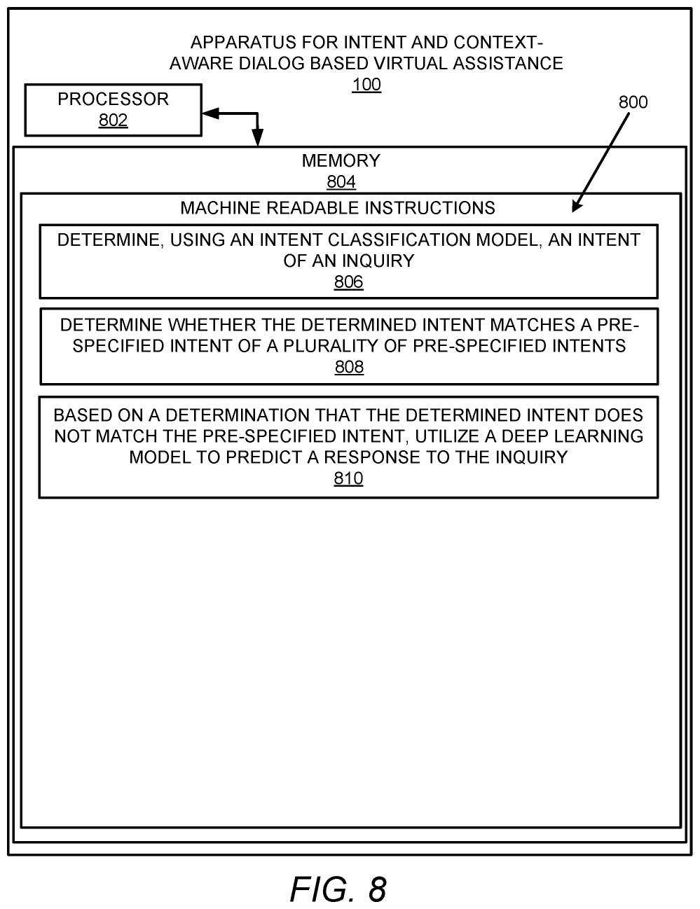

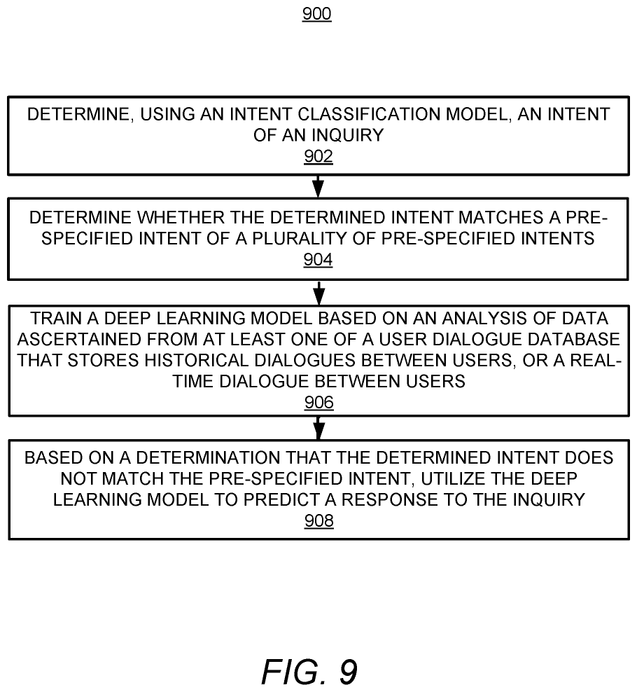

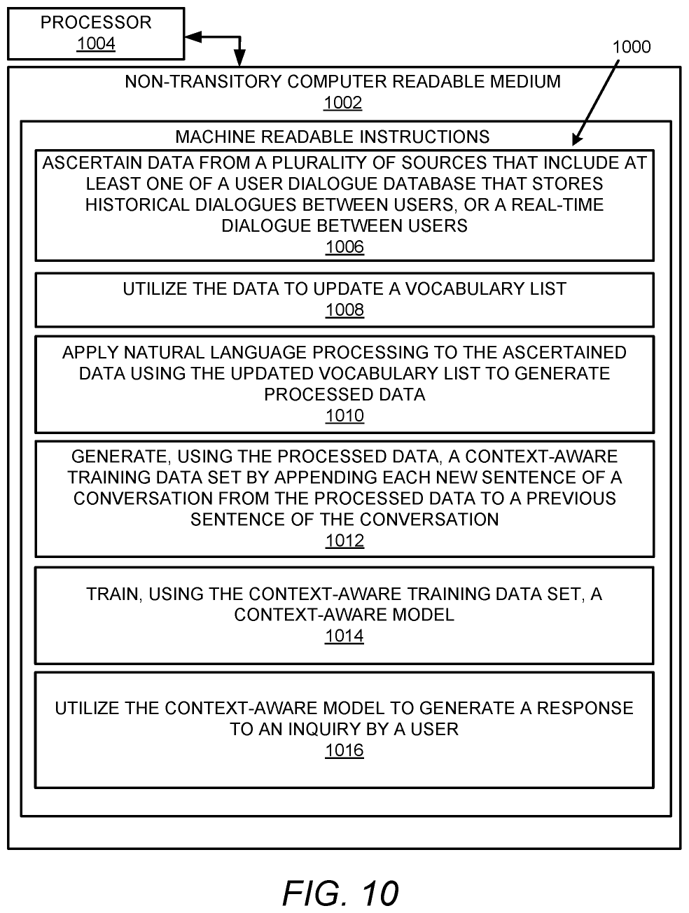

FIGS. 8-10 respectively illustrate an example block diagram 800, an example flowchart of a method 900, and a further example block diagram 1000 for intent and context-aware dialogue based virtual assistance. The block diagram 800, the method 900, and the block diagram 1000 may be implemented on the apparatus 100 described above with reference to FIG. 1 by way of example and not limitation. The block diagram 800, the method 900, and the block diagram 1000 may be practiced in other apparatus. In addition to showing the block diagram 800, FIG. 8 shows hardware of the apparatus 100 that may execute the instructions of the block diagram 800. The hardware may include a processor 802, and a memory 804 (i.e., a non-transitory computer readable medium) storing machine readable instructions that when executed by the processor 802 cause the processor to perform the instructions of the block diagram 800. The memory 804 may represent a non-transitory computer readable medium. FIG. 9 may represent a method for intent and context-aware dialogue based virtual assistance. FIG. 10 may represent a non-transitory computer readable medium 1002 having stored thereon machine readable instructions to provide intent and context-aware dialogue based virtual assistance. The machine readable instructions, when executed, cause a processor 1004 to perform the instructions of the block diagram 1000 also shown in FIG. 10.

The processor 802 of FIG. 8 and/or the processor 1004 of FIG. 10 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1002 of FIG. 10), such as hardware storage devices (e.g., RAM (random access memory), ROM (read only memory), EPROM (erasable, programmable ROM), EEPROM (electrically erasable, programmable ROM), hard drives, and flash memory). The memory 804 may include a RAM, where the machine readable instructions and data for a processor may reside during runtime.

Referring to FIGS. 1-8, and particularly to the block diagram 800 shown in FIG. 8, the memory 804 may include instructions 806 to determine, using an intent classification model 104, an intent of an inquiry 108.

The processor 802 may fetch, decode, and execute the instructions 808 to determine whether the determined intent matches a pre-specified intent of a plurality of pre-specified intents.

Based on a determination that the determined intent does not match the pre-specified intent, the processor 802 may fetch, decode, and execute the instructions 810 to utilize a deep learning model 126 to predict a response to the inquiry 108.

Referring to FIGS. 1-7 and 9, and particularly FIG. 9, for the method 900, at block 902, the method may include determining, using an intent classification model 104, an intent of an inquiry 108.

At block 904, the method may include determining whether the determined intent matches a pre-specified intent of a plurality of pre-specified intents.

At block 906, the method may include training a deep learning model 126 based on an analysis of data ascertained from at least one of a user dialogue database that stores historical dialogues between users, or a real-time dialogue between users.

At block 908, based on a determination that the determined intent does not match the pre-specified intent, the method may include utilizing the deep learning model 126 to predict a response to the inquiry 108.

Referring to FIGS. 1-7 and 10, and particularly FIG. 10, for the block diagram 1000, the non-transitory computer readable medium 1002 may include instructions 1006 to ascertain data 128 from a plurality of sources 130 that include at least one of a user dialogue database that stores historical dialogues between users, or a real-time dialogue between users.

The processor 1004 may fetch, decode, and execute the instructions 1008 to utilize the data to update a vocabulary list.

The processor 1004 may fetch, decode, and execute the instructions 1010 to apply natural language processing to the ascertained data using the updated vocabulary list to generate processed data.

The processor 1004 may fetch, decode, and execute the instructions 1012 to generate, using the processed data, a context-aware training data set by appending each new sentence of a conversation from the processed data to a previous sentence of the conversation.

The processor 1004 may fetch, decode, and execute the instructions 1014 to train, using the context-aware training data set, a context-aware model 134.

The processor 1004 may fetch, decode, and execute the instructions 1016 to utilize the context-aware model 134 to generate a response to an inquiry 108 by a user.

What has been described and illustrated herein is an example along with some of its variations. The terms, descriptions and figures used herein are set forth by way of illustration and are not meant as limitations. Many variations are possible within the spirit and scope of the subject matter, which is intended to be defined by the following claims—and their equivalents—in which all terms are meant in their broadest reasonable sense unless otherwise indicated.

1. An apparatus comprising:
a processor; and
a non-transitory computer readable medium storing machine readable instructions that when executed by the processor cause the processor to:
determine, using an intent classification model, an intent of an inquiry;
determine whether the determined intent matches a pre-specified intent of a plurality of pre-specified intents; and
based on a determination that the determined intent does not match the pre-specified intent, utilize a deep learning model to predict a response to the inquiry.

2. The apparatus according to claim 1, wherein the instructions to utilize the deep learning model to predict the response to the inquiry are further to cause the processor to:
based on the determination that the determined intent does not match the pre-specified intent, generate a question related to the inquiry;
determine, by analyzing a response to the question using the intent classification model, another intent of the inquiry;
determine whether the determined other intent matches another pre-specified intent of the plurality of pre-specified intents; and
based on a determination that the determined other intent does not match the other pre-specified intent, utilize the deep learning model to predict the response to the inquiry.

3. The apparatus according to claim 1, wherein the instructions are further to cause the processor to:
train the deep learning model based on an analysis of data ascertained from at least one of
a user dialogue database that stores historical dialogues between users, or
a real-time dialogue between users.

4. The apparatus according to claim 3, wherein the instructions are further to cause the processor to:
update a vocabulary list based on an analysis of the data; and
implement, using the updated vocabulary list, natural language processing on the data,
wherein the instructions to train the deep learning model based on the analysis of the data comprise instructions to cause the processor to train the deep learning model based on an analysis of the natural language processed data.

5. The apparatus according to claim 1, wherein the instructions to utilize the deep learning model to predict the response to the inquiry are further to cause the processor to:
determine a context of the inquiry, wherein the context represents a subject of the inquiry;
determine, by analyzing the context of the inquiry, a plurality of possible responses to the inquiry; and
utilize the deep learning model to predict, based on an analysis of the plurality of possible responses, the response to the inquiry.

6. The apparatus according to claim 5, wherein the instructions to utilize the deep learning model to predict the response to the inquiry are further to cause the processor to:
rank each response of the plurality of possible responses to the inquiry according to a relevance of a respective response to the inquiry; and
utilize the deep learning model to predict, based on an analysis of the ranked plurality of possible responses, the response to the inquiry.

7. The apparatus according to claim 5, wherein the instructions are further to cause the processor to:
generate a context-aware training data set by appending each new sentence of a conversation based on at least one of
historical dialogues between users, or
a real-time dialogue between users, to a previous sentence of the conversation; and
utilize the context-aware training data set to determine the context of the inquiry.

8. The apparatus according to claim 2, wherein, based on the determination that the determined other intent does not match the other pre-specified intent, the instructions to utilize the deep learning model to predict the response to the inquiry are further to cause the processor to:
determine, after completion of a predetermined number of attempts related to inquiry intent determination of the inquiry, whether the inquiry intent is determined; and
based on a determination that the inquiry intent is not determined, utilize the deep learning model to predict the response to the inquiry.

9. The apparatus according to claim 1, wherein the instructions are further to cause the processor to:
categorize different types of sentences to an intent category of a plurality of intent categories; and
train the intent classification model based on the categorization of the different types of sentences to the intent category of the plurality of intent categories.

10. The apparatus according to claim 1, wherein the instructions are further to cause the processor to:
based on a determination that the determined intent matches the pre-specified intent, generate the response associated with the inquiry.

11. A computer implemented method comprising:
determining, using an intent classification model, an intent of an inquiry;
determining whether the determined intent matches a pre-specified intent of a plurality of pre-specified intents;
training a deep learning model based on an analysis of data ascertained from at least one of
a user dialogue database that stores historical dialogues between users, or
a real-time dialogue between users; and
based on a determination that the determined intent does not match the pre-specified intent, utilizing the deep learning model to predict a response to the inquiry.

12. The method according to claim 11, wherein utilizing the deep learning model to predict the response to the inquiry further comprises:
determining a context of the inquiry, wherein the context represents a subject of the inquiry;
determining, by analyzing the context of the inquiry, a plurality of possible responses to the inquiry; and
utilizing the deep learning model to predict, based on an analysis of the plurality of possible responses, the response to the inquiry.

13. The method according to claim 12, wherein utilizing the deep learning model to predict the response to the inquiry further comprises:
ranking each response of the plurality of possible responses to the inquiry according to a relevance of a respective response to the inquiry; and
utilizing the deep learning model to predict, based on an analysis of the ranked plurality of possible responses, the response to the inquiry.

14. A non-transitory computer readable medium having stored thereon machine readable instructions, the machine readable instructions, when executed, cause a processor to:
ascertain data from a plurality of sources that include at least one of
a user dialogue database that stores historical dialogues between users, or
a real-time dialogue between users;
utilize the data to update a vocabulary list;
apply natural language processing to the ascertained data using the updated vocabulary list to generate processed data;
generate, using the processed data, a context-aware training data set by appending each new sentence of a conversation from the processed data to a previous sentence of the conversation;
train, using the context-aware training data set, a context-aware model; and
utilize the context-aware model to generate a response to an inquiry by a user.

15. The non-transitory computer readable medium according to claim 14, wherein the machine readable instructions, when executed, further cause the processor to:
categorize different sentences of the processed data according to a plurality of intent categories;
train, using the categorized sentences, an intent classification model; and
utilize the intent classification model and the context-aware model to generate the response to the inquiry by the user.
